(19) United States
(12) Patent Application Publication
(10) Pub. No.: US 2004/0005899 A1
(43) Pub. Date: Jan. 8, 2004

(54) Distributed location system

(76) Inventors: Joseph Nir, Rehovot (IL); Baruch Shayevits, Lezion (IL)

Correspondence Address: Mark Friedman, Bill Polkinghorn, Discovery Dispatch, 9003 Florin Way, Upper Marlboro, MD, 20772, US

(21) Appl. No.: 10/221,477

(22) PCT Filed: Feb. 16, 2001
(86) PCT No.: PCT/US01/04961

(30) Foreign Application Priority Data
Apr. 3, 2000 (US) 60194035

(51) Int. Cl. G06F 19/00

(52) U.S. Cl. 455/456.1

(57) ABSTRACT

A system for locating a mobile unit (12) of an unsynchronized cellular network, in which a assigned mobile unit (14) is a provisional reference mobile unit (14). The reference mobile unit (14) constantly tries to achieve self location, records base transceiver stations (16 and 18) location times, and synchronize available base transceiver stations (16 and 18) to its own clock, the base transceiver stations (16 and 18) are also synchronized to a system time reference of a navigation satellite system (10). A mobile unit (12) of a cell records reception times of base transceiver stations (16 and 18) and navigation satellites (10), synchronizing them as referenced by local clock. Mobile unit location (12) is processed at central location server or in the mobile unit (12), by collecting reception times, synchronization data from (14) and location parameters if available.

### FIELD OF THE INVENTION

The present invention relates generally to methods for locating mobile units of unsynchronized cellular network systems. More particularly the present invention deals with location methods based on signals of cellular base stations and navigation satellites.

### BACKGROUND OF THE INVENTION

The travel time of a signal from a radio source to a receiver of the source is used for ranging purposes. The travel time of the signal from the radio source having a known geographic location, to a receiver having an unknown location is measured, and multiplied by the speed of light to determine the distance between the radio source and the receiver. Common commercial navigation methods employ navigation satellites, typically of the GPS system, as radio sources. In the case of satellites however, the range between the receiver and a number of satellites is not enough for calculating geographical position of the receiver. Once the ranges to various satellites become known, the exact position of the satellites with respect to the earth at the exact time of range measurement must be taken into consideration and used as an input for calculating the geographical location of the receiver. In location systems that employ the signals of cellular networks as radio sources for navigation purposes, base stations (BTSs) are used as radio sources. The base stations are static and their geographic location are registered once, and loaded to a memory of the system. In WO-99-21028 a method is disclosed for locating a mobile unit of a digital telephone system, in which a reference receiver positioned at a known location receives signals of BTSs (base transceiver stations) of the telephone system, each having a known location. Another receiver, of unknown location receives the same signals and by calculating the time offsets between the respective reception times in each receiver, location is determined. Another method, disclosed in WO-99-61934 utilizes transmitted downlink signals of BTSs of a cellular network, utilizing them as ranging measurements. This invention also uses the signal of GPS satellites in combination with the cellular network based ranging approach. In this invention both signal sources are used to determine location of a mobile transceiver of the network.

### SUMMARY OF THE INVENTION

An object of the present invention is to provide a ranging system for determining a location of a mobile unit of a cellular system in which at least one other mobile unit is assigned for a reference unit of the network.

A further object of the present invention is to provide a method for using assigned mobile units for determining a location of other mobile units of the same unsynchronized cellular network. The required synchronization of the respective signals of the cellular BTSs (base stations) is achieved in a common assigned mobile unit by first receiving each signal by that mobile unit. The received signals bear each identifiable timing references which enable a synchronization to be made between each of the respective signals, all referenced to the clock of the receiving MU. One or more navigation satellite signals can be used as well as the BTS signals. If enough satellites are received, the geographical position of the assigned mobile unit can be determined independently and be sent to the location processing unit of the network together with the synchronization information of the BTSs signals.

Another object of the present invention is to provide a method for determining the location of a mobile receiver, by exploiting information provided by an assigned mobile receiver. Such information is combined with the information obtained by a mobile unit in a calculation center to determine the location of the mobile unit.

### BRIEF DESCRIPTION OF THE DRAWINGS

FIG. 1 is a schematic layout of the components of a system within which the present invention is implemented;

FIG. 2A is a flow chart describing the sequence of events taking place in the updating of a location server according to a preferred embodiment of the present invention;

FIG. 2B is a flow chart describing the sequence of events taking place in the updating of a location server, without reference unit being able to find enough satellites to fully determine its location;

FIG. 3 is a flow chart describing the sequence of events taking place further to the issuance of a request to locate a mobile unit.

### DETAILED DESCRIPTION OF THE PRESENT INVENTION

In accordance with the present invention, receivers of cellular network systems are located by using ranging methods which employ transmitted signals of radio sources.

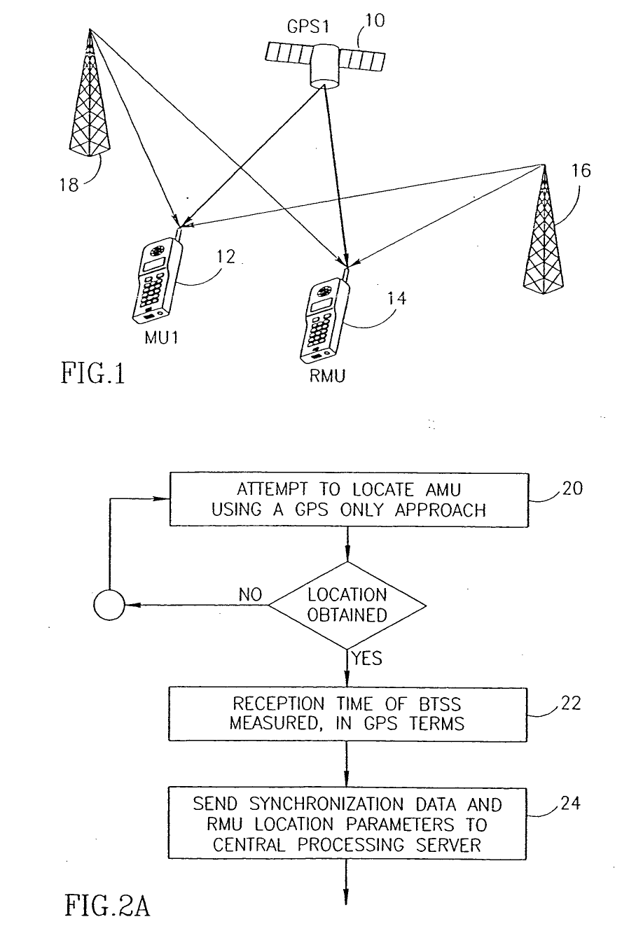

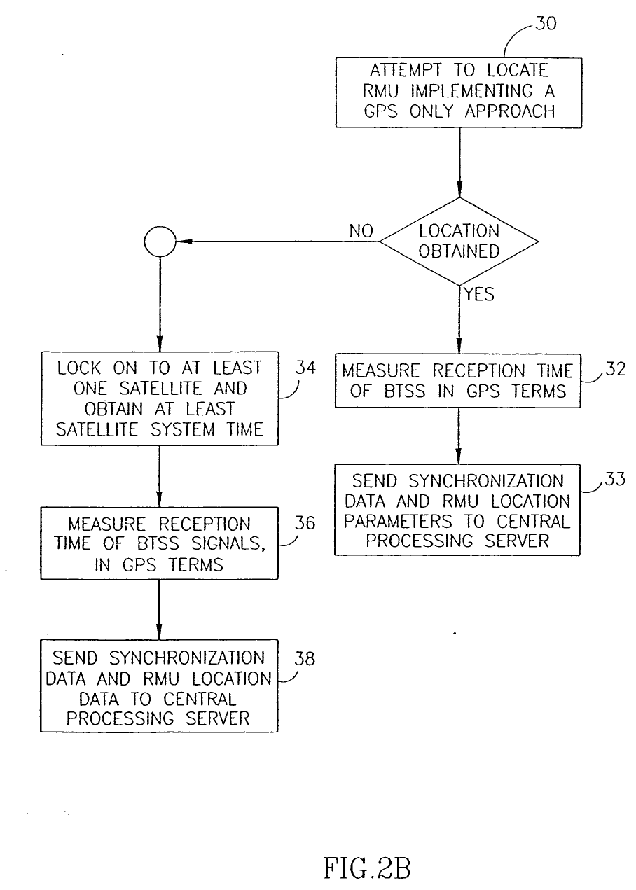

In a system of the present invention, MUs (mobile units) are allocated for use as provisional synchronizing elements of the network. Thus, an AMU (allocated MU), according to a preferred embodiment of the present invention, when active, becomes a RMU (reference mobile unit) which constantly updates its position preferably by regular GPS oriented measurements. The present invention also provides for conditions in which a full set of satellites required by any or all the MUs involved is not available. According to an embodiment of the present invention, the RMU extracts from the navigation satellite system at least satellite system time and makes it available for synchronizing signals of a cellular network. FIG. 1 describes schematically a minimal setup in which the present invention is implemented. Signals of a navigation satellite 10, typically a GPS satellite, are received by a MU 12 and by an RMU 14. The two mobile units also receive signals of BTSs (base stations) 16 and 18. FIG. 2A to which reference is now made, describes a sequence of events in accordance with a preferred embodiment of the invention that are carried out for the purpose of updating the location parameters of a RMU. In step 20 the RMU attempts to locate itself by GPS only reference. These attempts are repeated until the RMU is located. Such an approach is especially suitable for mobile units situated in open areas or moving units with a portion of their path located in open places. In step 22. The RMU measures the reception times of identifiable frames of available BTSs of a local cellular network, relative to the satellite system time signal. This will synchronize the transmission timing of the available BTSs with the satellite system time. The updated synchronization information is sent to a processing unit in a central location server of the network, as well as the location parameters of the RMU, in step 24. In another embodiment of the invention, described in FIG. 2B to which reference is now made, satellite location determination is not necessarily performed. In step 30 an attempt is made at the RMU to determine the location referring to satellite signals only. If such is made possible, the sequence continues through steps 32, in measuring the reception times of identifiable timing references of available BTSs of a local cellular network, relative to the satellite system time signal. The reception times of the BTSs and satellites signals are then used as input data for ranging purposes, and will therefore be referred to generally as location data if they are not used for locating the RMU singly. In step 33, the updated synchronization data and the location parameters of the RMU are sent to a location server of the network, to be processed by a processing unit. The synchronization between the BTSs and the satellite system time cannot be used for periods longer than a few tens of seconds because of the drift in the BTS clocks with respect to that of the satellite system. This drift is non linear and cannot be predicted, so that repeated synchronizations must be performed. For GSM systems, the various BTSs are not synchronized among themselves so that a separate matching must be performed for each base station. The clocks of the mobile units are of relative inferior stability and their respective offsets require extra measurements to be made in order to solve range equations, as is the case with regular GPS-based range finding. If no satellite location has been successfully made, the RMU locks on to at least one satellite to obtain at least system time in step 34. Consequently, in step 36 the reception time of available BTSs are measured by the local RMU clock, using satellite system time as reference. In step 38, synchronization data and RMU location data are sent to the central processing server for further location processing.

In extreme cases in which not even one satellite can be received well enough to obtain at least system timing, it is still possible to use a AMU according to the invention. In such cases, a margin is left for exclusive use of BTSs as radio sources for ranging and for time synchronization, along the lines of the implementation of the invention disclosed in WO-99-21028, the contents of which are incorporated herewith by reference. In other extreme cases of the framework of the invention, the mobile unit requesting location determination may achieve the task by full satellite location procedure, which in such a case renders the mutual synchronization of BTSs redundant.

As regards navigation satellites, downloading system time from one satellite sufficiently represents all the satellites of a navigation constellation a timing download of any other satellites because they are mutually synchronized. In the case that a RMU remains immobile, it is not necessary to do a full satellite location process constantly, even if all the required satellites for the task are available. In such a case, the system time measurement from one satellite is sufficient for use as a reference unit for the cellular system, and the RMU location should be reaffirmed at the location server.

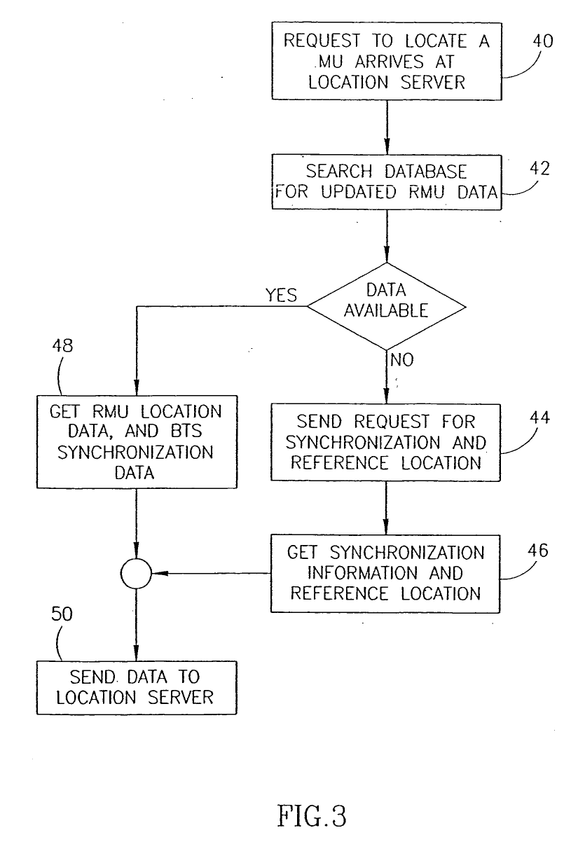

Upon receiving a request for location, the location server of the network sets off a sequence of steps in which new and old data are used. FIG. 3 to which reference is now made illustrates a sequence according to an embodiment of the invention. In step 40 a request to locate a MU is received in the location server of the network. In step 42 the database is searched for updated RMU data. If no such updated data exists, in step 44 the server sends a request, such as by cell-broadcast or by SMS (short messaging service) to the AMUs for location and synchronization data. In step 46 the location data and synchronization data is passed on to the location server. If RMU data is found in step 42, the updated synchronization and location data are collected in step 43. In each case, synchronization data and location data are sent to a location server in step 50. The actual location processing may be performed in a server of the network system, or it may be performed in the MU.

In the case that two satellites are available for the MU and a RMU, two BSTs are required for location of the MU. The satellites need not be the same satellites for the two MUs. The equation for the range (R) between MU and BTS1 is as follows:

R=[Time of reception of BTS1—signal in GPS terms (or synchronized BTS signal) in MU−time of transmission of BTS signal in GPS terms−MU clock bias]×C (speed of light). In symbolic notation:

R(MU−BTS1)=(TrecBTS1−TtransBTS1−ClkoffsetMU)×C 1

R(MU−BTS2)=(TrecBTS2−TtransBTS2−ClkoffsetMU)×C 2

R(AMU−BTS1)=(TrecBTS1−TtransBTS1−ClkoffsetAMU)×C 3

R(AMU−BTS2)=(TrecBTS2−TtransBTS2−ClkoffsetAMU)×C 4

Four more measurements to the two satellites complete the set.

R(MU−GPS1)=(TrecMU−ClkoffsetMU)×C 5

R(MU−GPS2)=(TrecMU−ClkoffsetMU)×C 6

R(AMU−GPS1)=(TrecAMU−ClkoffsetAMU)×C 7

R(AMU−GPS2)=(TrecAMU−ClkoffsetAMU)×C 8

In this set of equations there are unknown variables: two clock offsets (one for each MU), TtransBTS1, TtransBTS2, R(AMU−GPS2), R(AMU−GPS1), R(MU−GPS2), R(MU−GPS1).

The Privacy Issue

The assignment of MUs for provisional synchronization elements of the network raises issues of protection of privacy. Upon updating of the AMU location parameters in the location server's database, a potential violation of privacy is committed. The implementation of the present invention implies therefore the application of special measures to protect privacy. As a possible remedy for the problem, the information sent to the location server's database would not contain the respective telephone numbers of the associated receivers.

1. A system for determining a location of a first MU (mobile unit) of a cellular network, capable of receiving both cellular network signals and navigation satellite signals, comprising:
a second MU of said network capable of receiving both cellular network signals and navigation satellite signals, assigned for a provisional reference unit,
a plurality of radio sources for sending timing references, and
a location processing unit of said cellular network.

2. A system for determining a location of a first MU (mobile unit) of a cellular network as in claim 1, and wherein said location processing unit is a component of said MU.

3. A system for determining a location of a MU (mobile unit) of a cellular network as in claim 1, and wherein said location processing unit is a component of a central location server.

4. A system for determining a location of a first MU (mobile unit) of a cellular network as in claim 1, and wherein said plurality of radio sources are BTSs (base transceiver) stations of said cellular network.

5. A system for determining a location of a first MU (mobile unit) of a cellular network as in claim 1, and wherein at least one of said radio sources is a navigation satellite.

6. A method for determining location of a first MU (mobile unit) of a cellular network, wherein said first MU receives signals of a first plurality of signals bearing identifiable timing references transmitted from respective radio sources, comprising:
measuring respective reception times of a second plurality of radio sources in a second MU assigned for a provisional reference unit, wherein at least one BTS (base transceiver station) is received by said second MU,
downloading available navigation satellite data by said second MU,
calculating synchronization between said second plurality of radio sources,
calculating location parameters of said second MU,
transferring said respective reception times and location parameters of said second MU assigned for a provisional reference unit, to a location processing unit,
measuring respective reception times of said first plurality of radio sources in said first MU, and
calculating a location of said first MU by comparing said reception times of said first plurality of radio sources by said first MU with said reception times of said second plurality of radio sources of said second MU, whereby said second MU having location parameters and whereby said first MU receives signals of said at least one BTS received by said second MU.

7. A method for determining a location of a first MU (mobile unit) of a cellular network as in claim 6, and wherein one of said second plurality of radio sources received by said second MU is a navigation satellite.

8. A method for determining a location of a first MU (mobile unit) of a cellular network as in claim 6, and wherein two of said second plurality of radio sources received by said second MU are navigation satellites.

9. A method for determining a location of a first MU (mobile unit) of a cellular network as in claim 6, and wherein said location parameters of said second MU are obtained exclusively by satellite navigation methods.

10. A method for determining location of a first MU (mobile unit) of a cellular network, wherein said first MU receives signals of a first plurality of signals bearing identifiable timing references transmitted from respective radio sources, comprising:
measuring respective reception times of a second plurality of radio sources in a second MU assigned for a provisional reference unit, wherein at least one BTS (base transceiver station) is received by said second MU,
downloading system time of a navigation satellite system by said second MU,
calculating synchronization between said second plurality of radio sources,
calculating location data of said second MU,
transferring said respective reception times and said satellite system time by said second MU assigned for a provisional reference unit, to a location processing unit,
measuring respective reception times of said first plurality of radio sources in said first MU, and
calculating a location of said first MU by comparing said reception times of said first plurality of radio sources by said first MU with said reception times of said second plurality of radio sources of said second MU, whereby said second MU having location data and whereby said first MU receives signals of said at least one BTS received by said second MU.

11. A method for determining a location of a first MU (mobile unit) of a cellular network as in claim 10, and wherein one of said second plurality of radio sources received by said second MU is a navigation satellite.

12. A method for determining a location of a first MU (mobile unit) of a cellular network as in claim 10, and wherein two of said second plurality of radio sources received by said second MU are navigation satellites.
